(19) United States
(12) Patent Application Publication
(10) Pub. No.: US 2009/0178316 A1
(43) Pub. Date: Jul. 16, 2009

(54) POST COVER WITH INTERCHANGEABLE ADVERTISING HOLDER

(75) Inventors: Chris Parenti, Novi, MI (US); Loren Venegas, Canton, MI (US)

Correspondence Address: GIFFORD, KRASS, SPRINKLE,ANDERSON & CITKOWSKI, P.C, PO BOX 7021, TROY, MI, 48007-7021, US

(73) Assignee: Ideal Shield, LLC, Detroit, MI (US)

(21) Appl. No.: 12/015,337

(22) Filed: Jan. 16, 2008

(51) Int. Cl. G09F 13/04; G09F 19/00

(52) U.S. Cl. 40/564; 40/606.12

(57) ABSTRACT

Non-illuminated and illuminated post-cover displays include a generally cylindrical body having and open lower end adapted for placement over a post extending upwardly from a ground surface. The upper end of the body includes an advertising holder comprising a transparent or translucent form having an open top and an inner surface to receive an insert bearing textual or graphical material visible through the transparent or translucent form when installed. A cap is provided to close off the open top of the transparent or translucent form. The cap may be removable, allowing the insert to be changed, or it may be permanently affixed to the transparent or translucent form. The body and transparent or translucent form may be fabricated as an integrally molded article or portions may be assembled. In the preferred embodiment, the transparent or translucent form is generally cylindrical and the insert is a flexible sheet. In the non-illuminated embodiment the insert may be opaque. In the illuminated embodiment, however, the insert contains one or more transparent or translucent portions and the cap includes a light source to back-light the insert through the transparent or translucent form.

### FIELD OF THE INVENTION

This invention relates generally to post covers or sleeves and, in particular, to a cover having an interchangeable advertising holder.

### BACKGROUND OF THE INVENTION

There exists a vast variety of advertising posts. Early examples are shown in U.S. Pat. Nos. 1,066,493; 1,402,105; and 1,740,845.

Commonly assigned U.S. Pat. No. 6,779,287, entitled “Integral post sleeve and sign” discloses a combined sleeve having an open bottom which fits over a post or other vertical member includes an integrated message panel formed in the upped end when installed. The combined sleeve and sign holder according to the invention is preferably made of synthetic/polymeric material such as polyethylene, polypropylene, vinyl, or any other sufficiently durable material, using any suitable process, including an injection mold, blow mold, or rotational-type mold. Depending upon the process used, the article may be fabricated as a unitary structure, or components may be joined through any suitable form of attachment process, including the use of adhesives and/or welding. The message may be supported to the sleeve in a variety of ways, depending upon the need for interchangeability vs. permanence. In the preferred embodiment, the signage is filly integrated into the upped end through the use of decals, which are included in the mold and integrally formed with the article during the molding process. In alternative embodiments a sign holder may be provided, enabling a changeable message to be loaded either from the front, or back, or both. A transparent forward panel may also be included to protect the signage.

There are also lighted advertising signs. U.S. Pat. No. 6,802,143, for example, describes a “reliable,” rotating, illuminated advertising display unit that utilizes independent display modules housing lights and advertising material. These are easily removed from the base unit for shipping, assembly, and replacement. Optionally, AMLCD (active matrix liquid-crystal display), plasma, or similar flat-panel displays may be used in the display modules. The display modules surround a hollow central compartment that may be used for storing, collecting, or displaying products such as food or beverages, or as a trash container. Power is transmitted from the base via a slip ring to the lighting contained in the display modules so as to display advertising or similar matter. The rotational capability is provided via a motor, a gearing arrangement, a central tapered roller bearing, and rollers. The unit's power is provided by AC power when available, or by utilizing a fuel cell, e.g., a proton exchange membrane (PEM), methanol solid oxide, photovoltaic cells, battery, or some combination thereof.

Commonly assigned U.S. Pat. No. 7,150,117 is directed to a back-lit stenciled post cover. A post assembly with illuminated information includes a hollow tube extending upwardly from a ground surface, the tube having a sidewall with textual or graphical information cut therethrough. A lighting assembly is disposed within the hollow tube, and a transparent or translucent sleeve positioned over the tube such that when the lighting assembly is activated, the textual or graphical information is visible through the transparent or translucent sleeve. The lighting assembly may include a flashing light. In the preferred embodiment the hollow tube is metal, and the transparent or translucent sleeve is constructed of plastic. The lighting assembly preferably comprises one or more fluorescent tubes. The textual or graphical information may be traffic-related, or it may concern other directives. The post preferably has a circular cross-section in the range of 2 to 10 inches, and an optional base may be provided for mounting to a ground surface.

Despite these articles, the need remains for a post cover having an interchangeable advertising holder that may also be illuminated.

### SUMMARY OF THE INVENTION

This invention resides in display apparatus having non-illuminated and illuminated embodiments. Both include a generally cylindrical body having and open lower end adapted for placement over a post extending upwardly from a ground surface. The upper end of the body includes an advertising holder comprising a transparent or translucent form having an open top and an inner surface to receive an insert bearing textual or graphical material visible through the transparent or translucent form when installed. A cap is provided to close off the open top of the transparent or translucent form.

The cap may be removable, allowing the insert to be changed, or it may be permanently affixed to the transparent or translucent form. The body and transparent or translucent form may be fabricated as an integrally molded article or portions may be assembled. In the preferred embodiment, the transparent or translucent form is generally cylindrical, and the insert is a flexible sheet.

In the non-illuminated embodiment the insert may be opaque. In the illuminated embodiment, however, the insert contains one or more transparent or translucent portions and the cap includes a light source to back-light the insert through the transparent or translucent form. The cap preferably further includes a rechargeable battery, a solar panel to recharge the battery, and wherein the light source is powered by the battery. The cap may further a photocell causing the light source to be activated only when it is sufficiently dark outside, and/or a proximity detector causing the light source to be activated only when a viewer is proximate to the display apparatus.

### BRIEF DESCRIPTION OF THE DRAWINGS

FIG. 1 is perspective view of a non-illuminated embodiment of the invention in a partially exploded form;

FIG. 2 shows the embodiment of FIG. 1 in assembled form;

FIG. 3 is perspective view of an illuminated embodiment of the invention in a partially exploded form; and

FIG. 4 shows the embodiment of FIG. 3 in assembled form.

### DETAILED DESCRIPTION OF THE INVENTION

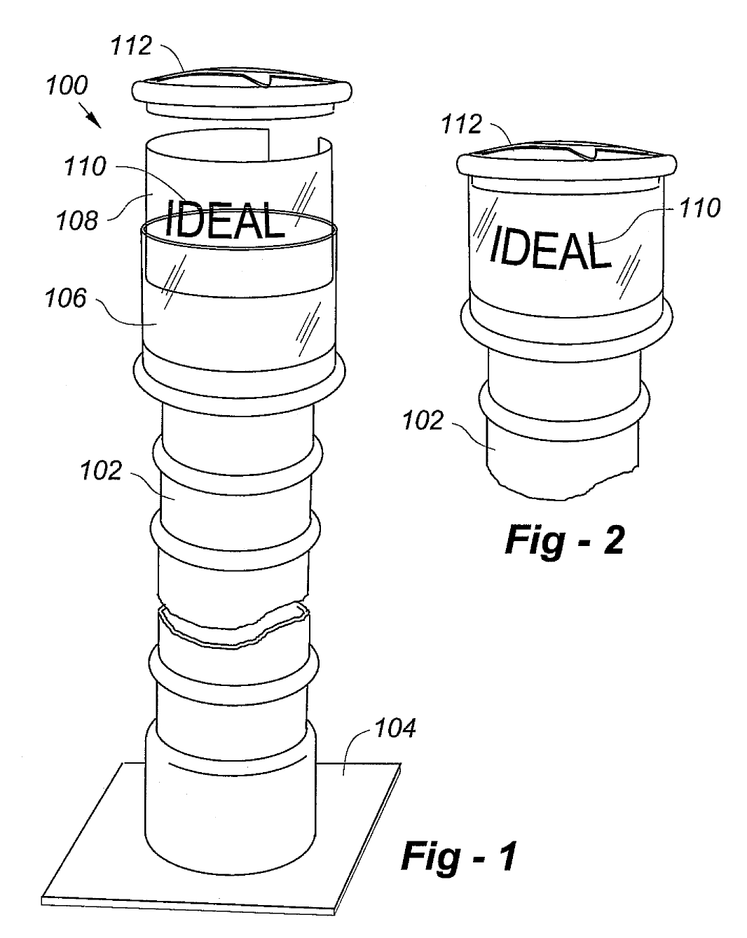

FIG. 1 is perspective view of a non-illuminated embodiment of the invention in a partially exploded form depicted generally at 100. FIG. 2 shows the embodiment of FIG. 1 in assembled form. The system in this case includes an elongate, hollow cylindrical body 102 having an open bottom enabling the body to be positioned over a pole, post or stanchion (not shown). The body has an internal diameter in the range of 2 to 10 inches, and a length on the order of 3 to 10 feet. An optional base 104 may be provided for mounting to a ground surface.

In the preferred embodiment, the upper end of the body 102 includes an advertising holder comprising a transparent or translucent form 106 with a cylindrical cross section larger than that of body 102. A flexible sheet 108 containing text or graphics 110 is placed within form 106 so that the indicia 110 is visible through the form 106. A cap 112 is the placed over and within the form 106, resulting in the assembled structure shown in FIG. 2. The cap may either use an interfere fit, with or without fasteners enabling the sheet 108 to be changed, or it may be glue in position for a permanent display. The outwardly extending circumferential ribs on body 102 and star-shaped pattern on the top of cap 112 are merely decorative.

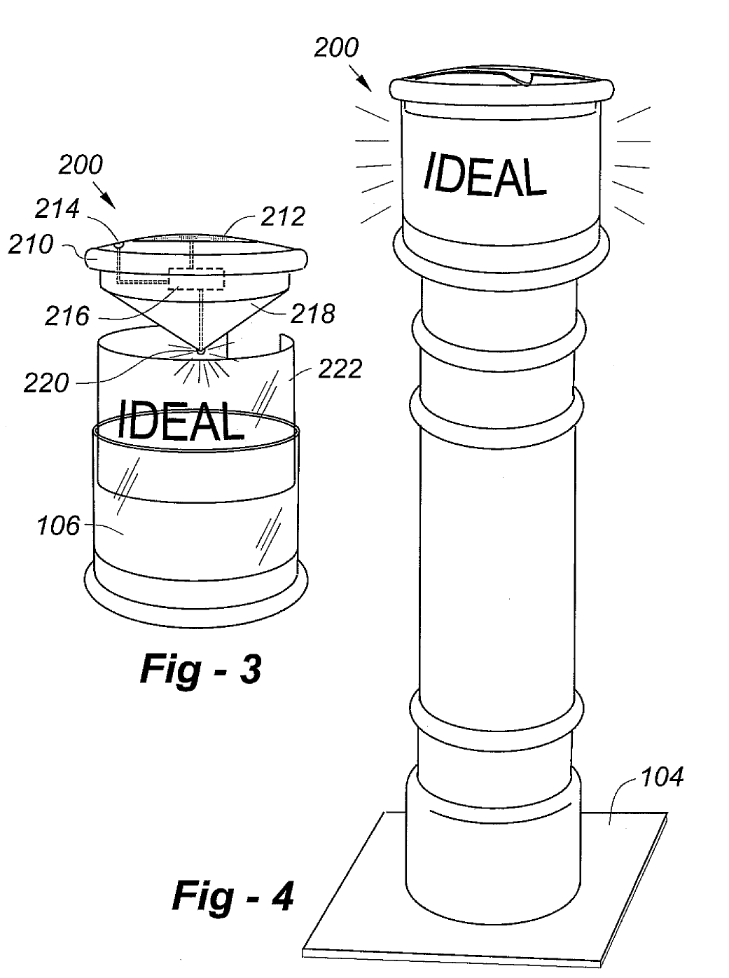

FIG. 3 is perspective view of an illuminated embodiment of the invention in a partially exploded form shown generally at 200, and FIG. 4 shows the embodiment of FIG. 3 in assembled form. In this case the base may be identical to that shown in FIGS. 1 and 2. The form 106 may also be shaped similarly though in this embodiment it is transparent or translucent. Again, a flexible sheet 222 containing text or graphics 110 is placed within form 106 so that the indicia 110 is visible through the form 106. However in this instance at least portions of the sheet 222 are transparent or translucent as well enabling back-light 220 to illuminate the display as shown in FIG. 4.

The light source 220 is preferably comprised of one or more High-intensity light-emitting diodes driven by electronics unit 216. Power for the unit 216 and emitter(s) 220 is derived in the preferred embodiment through solar panel 212 used to charge a battery (not shown) in unit 216. To conserve battery power, a photocell 214 coupled to unit 216 keeps emitter(s) 216 from turning on until it is sufficiently dark outside. The unit 216 may be programmed to illuminate differently colored emitters 220 to glow at different times or cause the light(s) to flash for greater attention gathering. A proximity detector (not shown) may also be used to illuminate the display only when an observer is near to further conserve battery power.

The combined sleeve and sign holders according to the invention are preferably made of synthetic/polymeric or plastic material such as polyethylene, polypropylene, vinyl, or any other sufficiently durable material, using any suitable process, including an injection mold, blow mold, or rotational-type mold. Depending upon the process used, the article may be fabricated as a unitary structure, or components may be joined through any suitable form of attachment process, including the use of adhesives and/or welding. The message may be supported against the form 106 in a variety of ways, depending upon the need for interchangeability vs. permanence. For an entirely permanent construction, the signage may be fully integrated into the upped end through the use of decals, which are included in the mold and integrally formed with the article during the molding process.

We claim:

1. Display apparatus, comprising:
a generally cylindrical body having and open lower end adapted for placement over a post extending upwardly from a ground surface and an upper end including an advertising holder;
the advertising holder comprising a transparent or translucent form having an open top and an inner surface to receive an insert bearing textual or graphical material visible through the transparent or translucent form when installed; and
a cap to close off the open top of the transparent or translucent form.

2. The display apparatus of claim 1, wherein the cap is removable, allowing the insert to be changed.

3. The display apparatus of claim 1, wherein the cap is permanently affixed to the transparent or translucent form.

4. The display apparatus of claim 1, wherein the body and transparent or translucent form are fabricated as an integrally molded article.

5. The display apparatus of claim 1, wherein the transparent or translucent form is generally cylindrical.

6. The display apparatus of claim 1, wherein the insert is a flexible sheet.

7. The display apparatus of claim 1, wherein:
the insert contains one or more transparent or translucent portions; and
the cap includes a light source to back-light the insert through the transparent or translucent form.

8. The display apparatus of claim 1, wherein:
the insert contains one or more transparent or translucent portions; and
the cap includes:
a rechargeable battery,
a solar panel to recharge the battery, and
wherein the light source is powered by the battery.

9. The display apparatus of claim 1, wherein:
the insert contains one or more transparent or translucent portions; and
the cap includes:
a rechargeable battery to power the light source,
a solar panel to recharge the battery, and
a photocell causing the light source to be activated only when it is sufficiently dark outside.

10. The display apparatus of claim 1, wherein:
the insert contains one or more transparent or translucent portions; and
the cap includes:
a rechargeable battery to power the light source,
a solar panel to recharge the battery, and
a proximity detector causing the light source to be activated only when a viewer is proximate to the display apparatus.
